(19) United States
(12) Patent Application Publication
(10) Pub. No.: US 2017/0084280 A1
(43) Pub. Date: Mar. 23, 2017

(54) Speech Encoding

(71) Applicant: Microsoft Technology Licensing, LLC, Redmond, WA (US)

(72) Inventors: Sriram Srinivasan, Sammamish, WA (US); Warren Lam, Redmond, WA (US); Xiaoqin Sun, Redmond, WA (US)

(21) Appl. No.: 14/861,723

(22) Filed: Sep. 22, 2015

(51) Int. Cl. G10L 19/005; G10L 19/002

(52) U.S. Cl. CPC G10L 19/005; G10L 19/002

(57) ABSTRACT

There is provided method comprising: in response to receiving a request for providing an encoded payload; encoding a first payload using at least three different data rates; outputting the encoded first payloads to respective buffers; and transmitting at least two of the encoded first payloads in respective frames, wherein the later transmitted encoded first payload is encoded at a data rate that is equal to or less than the data rate used to encode the first transmission of the first payload.

### BACKGROUND

Real-time communication applications transmit audio packets over communication networks using packet-based protocols. These networks are susceptible to packet losses, particularly on wireless networks, such as WiFi (as defined by the 802.11 set of standards) and mobile/cellular networks, which adversely affects audio quality transmitted as part of real-time communication applications.

There are a variety of techniques to help mitigate the effects of packet losses. One of these techniques is known as forward error correction (or FEC). The idea of FEC is to send the same information multiple times (often encoded in different ways), with the second (and any subsequent) reception being used to detect and correct for a limited number of errors in the initial transmission. Compared to the case in which FEC is not used at all, such an arrangement can reduce the number of retransmissions that have to be requested by the receiving entity.

There are two types of FEC that exist: In-band FEC; and Out-of-band FEC.

In-band FEC, also known as internal FEC, encodes redundant information as part of a bitstream generated by a voice encoder. This scheme is present in codecs such as SILK and Opus. A codec is a computer program and/or a physical device that can encode and/or decode a data stream. SILK is a proprietary audio codec useable for compressing and encoding audio data. Opus is an audio coding format developed by the Internet Engineering Task Force. Both of these codecs support a variable bitrate redundancy, but the implementation details for this are codec dependent. This means that any change to improve the FEC scheme can break bitstream compatibility (i.e. with the operating codec on the receiving side), and so changes to the FEC scheme are normally developed separately for each codec being used.

Out-of-band FEC, also known as external FEC, encodes redundant information independently of the codec being used to transmit the data. One possible example of this is when a copy of one of three previously encoded frames is transmitted in a packet with a current frame. As the frame is retransmitted at the same bitrate as the initial transmission, this method is called the “100% frame replication method”). This method incurs a large overhead for redundancy and does not support a variable bitrate redundancy.

### SUMMARY

The inventors have realised that there is a need for a new way of implementing FEC that can be applied to a variety of different codecs.

As mentioned above, in-band FEC offers some flexibility in terms of distributing the bitrate between the main and redundant encodes, but is limited with respect to its universal applicability to multiple codec types.

For example, in-band FEC cannot be changed/tuned without also changing the encoded bit-stream format. Such operations are specific to the requirements of a particular operating protocol, and are difficult to replicate across different protocols, which have different set parameters. Example parameters that may be difficult to tune when using in-band FEC and control FEC parameters include, the maximum frame or packet distance between a main payload and its redundant copy and the various trigger levels and thresholds for Opus and other future candidate codecs such as the enhanced voice services (EVS) codec, developed by 3GPP.

The inventors have realised that external FEC provides more flexibility for tuning and control without breaking bit-stream compatibility.

With respect to the particular external FEC system mentioned above, in which a copy of a previously transmitted frame is transmitted for providing FEC (the so-called 100% frame replication method), the inventors have realised that there are additional problems that can crop-up through use of this technique at low bitrate conditions. For example, the low bitrate code would have to be applied to the main encode (the encoding bitrate applied to the first transmission of a particular payload) to ensure that the repeat transmission of that payload is also made at a low bitrate. Further, under severely low bandwidth conditions, it may be that FEC cannot be used at all. Even when not under low bitrate conditions, this 100% frame replication method can be expensive to a user as the transmission of the redundancy payloads can increase the total data usage for transmitting an audio stream.

To the effect of addressing these and other problems, the inventors have proposed the presently described system.

According to a first aspect, there is provided method comprising: in response to receiving a request for providing an encoded payload; encoding a first payload using at least three different data rates; outputting the encoded first payloads to respective buffers; and transmitting at least two of the encoded first payloads in respective frames, wherein the later transmitted encoded first payload is encoded at a data rate that is equal to or less than the data rate used to encode the first transmission of the first payload.

Said encoding the first payload using at least three data rates may comprise: encoding the first payload using a first data rate to create a first encoded first payload; encoding the first encoded first payload using a second data rate to create a second encoded first payload; and encoding one of the first and second encoded first payloads using a third data rate to create a third encoded first payload.

The request may comprise the total available audio bitrate and an expected packet loss rate. The method may further comprise: determining the at least three data rates in dependence on the total available audio bitrate and the expected packet loss rate. The method may further comprise: obtaining speech characteristics of audio in the first payload, and wherein the determining is further performed in dependence on said speech characteristics.

The method may further comprise: transmitting the first payload encoded using a first data rate in a first packet; transmitting the first payload encoded using a second data rate in a second packet, subsequent to the first packet; and transmitting the first payload encoded using the second data rate in a third packet, subsequent to the second packet.

The method may further comprise: transmitting the first payload encoded using a first data rate in a first packet; transmitting the first payload encoded using a second data rate in a second packet, subsequent to the first packet; and transmitting the first payload encoded at a third data rate in a third packet, subsequent to the second packet.

The method may further comprise: transmitting two versions of the same payload in the same packet. The two versions of the same payload may be encoded using the same data rate. The method may further comprise: encoding a second payload using a plurality of different data rates; and transmitting at least one of the encoded second payloads in the third packet.

According to a second aspect, there is provided an apparatus comprising: at least one processor; and a memory comprising code that, when executed on the at least one processor, causes the apparatus to: in response to receiving a request for providing an encoded payload; encode a first payload using different data rates; output the encoded first payloads to respective buffers; and transmit at least two of the encoded first payloads in respective packets, wherein the later transmitted encoded first payload is encoded at a data rate that is equal to or less than the data rate used to encode the first transmission of the first payload.

The memory may comprise further code that, when executed on the at least one processor, causes the apparatus to encode a first payload using different data rates by: encoding the first payload using a first data rate to create a first encoded first payload; encoding the first encoded first payload using a second data rate to create a second encoded first payload; and encoding one of the first and second encoded first payloads using a third data rate to create a third encoded first payload.

The request may comprise the total available audio bitrate and an expected packet loss rate. The memory may comprise further code that, when executed on the at least one processor, causes the apparatus to: determine the different data rates in dependence on the total available audio bitrate and the expected packet loss rate. The memory may comprise further code that, when executed on the at least one processor, causes the apparatus to: obtain speech characteristics of audio in the first payload, and wherein the determining is further performed in dependence on said speech characteristics.

The memory may comprise further code that, when executed on the at least one processor, causes the apparatus to: transmit the first payload encoded using a first data rate in a first packet; and transmit the first payload encoded using a second data rate in a second packet, subsequent to the first packet; and transmit the first payload encoded using the second data rate in a third packet, subsequent to the second packet.

The memory may comprise further code that, when executed on the at least one processor, causes the apparatus to: transmit the first payload encoded using a first data rate in a first packet; and transmit the first payload encoded using a second data rate in a second packet, subsequent to the first packet; and transmit the first payload encoded using a third data rate in a third packet, subsequent to the second packet.

The memory may comprise further code that, when executed on the at least one processor, causes the apparatus to: transmit two versions of the same payload in the same packet.

The memory may comprise further code that, when executed on the at least one processor, causes the apparatus to: encode a second payload using a plurality of data rates; and transmit at least one of the encoded second payloads in the third packet.

According to a third aspect, there is provided a computer program comprising code means adapted to cause performing of the steps of any of the method claims when the program is run on data processing apparatus.

### FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user terminal;

FIG. 3 is a schematic illustration of processes performed by an encoder according to an embodiment;

FIG. 4 is a schematic illustration of an encoder according to the 100% frame replication method;

FIG. 5 shows traces for audio and video calls of mean-opinion score and duration against the uplink audio bandwidth; and

FIG. 6 is a schematic illustration of an encoder according to an embodiment.

### DESCRIPTION

In the following, there is described a system in which an encoder is arranged to, in response to an instruction to the encoder to provide an encoded payload, select and apply respective bitrates for encoding a payload in both a main form (for the initial transmission of that payload) and at least two a redundant forms (for a subsequent transmission to the initial transmission). The redundant payload copies can be encoded by the encoder at different bitrates to the main payload copy, in dependence on the selected rate. In essence, this means that a main payload (i.e. an encoded payload that is to be transmitted as an initial transmission of that payload) can be transmitted in a first packet, having been encoded at a first bitrate, and that a redundant copy of that payload (i.e. a version of the same payload as the main payload) can be transmitted in a second packet, having been encoded at a second bitrate, where the second bitrate is the same as or lower than the first bitrate and the second packet is transmitted after the transmission of the first packet. The redundant copy of that payload can be selected from the plurality of redundant copies formed at different bitrates and the initial transmission. The selection may be made in dependence on a target bitrate for the packet in which the redundant copy is to be transmitted. These operations are performed in response to a single request/instruction to return an encoded payload for transmitting in a frame as part of a packet.

In the case that there is a given total bitrate budget R for transmitting data packets over a network and a determined packet loss rate, the transmitting system is configured to determine a bit allocation for encoding the main and redundant payloads. For example, if the first (main) payload is encoded at a bitrate of R1, and the redundant copy of the first payload (the redundant payload) is encoded at a bitrate of R2, R1 and R2 are selected by the transmitting apparatus such that the perceptual quality of the decoded audio signal at the receiving end is maximized while satisfying the constraint R1+R2=R. The redundant and main audio payloads may be encoded using different codecs or the same codec at their respective bitrates. However, it is understood that the encoder may be configured to provide more than two copies/versions of a particular payload, encoded at respective rates, in order for a transmitter to select between for transmission. Different copies/versions of a particular payload may be transmitted in the same or in different packets, although it is understood that the first transmission of this payload is usefully transmitted in a separate packet to the first redundant transmission.

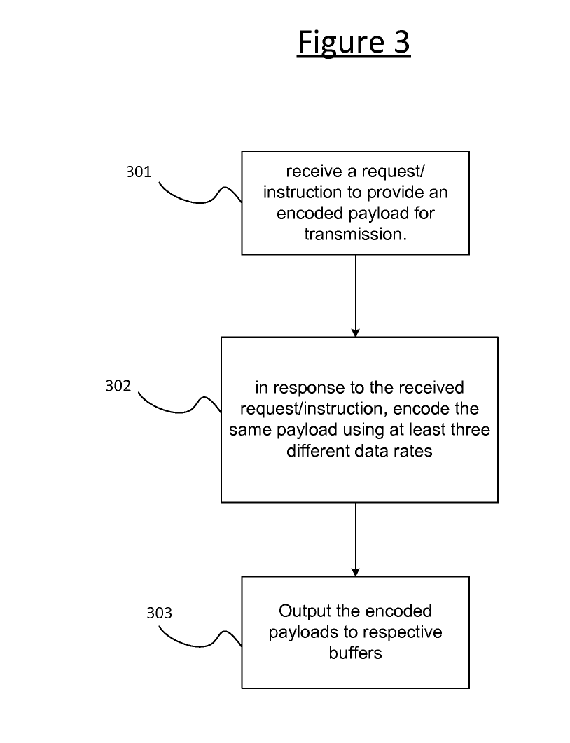

The steps performed by such an apparatus when encoding the payloads can be illustrated with respect to FIG. 3. Throughout the following, the term “encoder” will be used to denote at least the logical (i.e. software) and, on occasion the physical (i.e. hardware) parts of the transmitting entity that is encoding data for transmission.

At Step 301, the encoder receives a request/instruction to provide an encoded payload for transmission.

At Step 302, in response to the received request/instruction, the encoder encodes the same payload at least three times, using different bitrates. Where different bitrates are used, the payload encoded at the higher rate is known as the main or initial payload whilst the payload encoded at the lower rate is known as the redundant payload. The main (or initial payload) is the first copy of the payload that is scheduled for transmission. For clarity throughout the following, the bitrate of the main payload will be considered as the first data rate and the bitrate of the first transmitted redundancy payload will be considered as the second data rate. The first and second data rate may be the same, or may be different. For simplicity throughout the following, the redundant copy will be treated as being a copy/version of the payload that is encoded at a lower bitrate to that of the initial/main payload, although it is understood that this is not limiting, and that the redundant copy may instead be transmitted at the same bitrate as the main payload.

At Step 303, the encoded payloads are output to respective buffers. The main and redundant encoded payloads may be transmitted in respective frames. The encoded payloads may further be transmitted in respective packets.

The encoding of redundant payloads using a different (e.g., second, third, fourth, etc.) data rates may be performed in a variety of different ways. One way is to produce the main and the redundant packets in parallel, with no overlapping steps. This can result in an inefficient use of resources in the transmitting device. An improved option would be for at least part of the production of both the main and redundant payload to be performed simultaneously. For example, the production of the main payload and the redundant payload may share all of the same encoding steps except the last step (quantisation). Thus, in this example, when encoding the main and redundant payloads, when the encoder is about to perform a quantisation operation to at least partly set the bit rate, a duplicate payload may be produced and quantised separately. Thus, in this case, only the quantisation steps are performed independently (and/or in parallel) when producing the main and redundant payloads. This enables a saving in processing power of the encoder, as the encoder does not have to perform multiple complete encoding operations (i.e. one for the main payload and others for the redundant payload). Another way of saving processing power in this way is for the main payload to be fully encoded, and for the encoding of the redundant payloads to be performed on this encoded main payload. In this case, the redundant payloads are produced by using all of the same steps as the main payload and comprise the additional step of further quantisations for re-encoding the main payload at the second, third, fourth, etc. data rates for producing the redundant payloads. It is understood that the last quantisation step may involve multiple quantisation operations.

The request to provide the encoded payload may comprise the total available bitrate and an expected packet loss rate. This information can be used by the encoder for determining the different data rates at which to encode the payload. For example, if there is a relatively high packet loss rate, it is more useful to employ FEC than when there is a lower packet loss rate. The encoder may use this information to determine the frequency with which FEC information should be provided in a stream of packets. Further, the total available bitrate may be used by the encoder to determine the relative distribution in bits/bitrates between the first rate, R1, and the second rate, R2, of encoding of the first payload. Further, this information may be used to select the maximum first rate, R1, with multiple encodings at rates less than R1 being made for forming potential redundant payloads.

Where the payload comprises audio data, the encoder may be further configured to obtain speech characteristics of the audio data in the first payload, and to use this information to further determine the different data rates. For example, where there is a lot of activity/speech in the audio data, this may be indicative that a larger bit rate should be applied when encoding the main payload to increase the likelihood of the main payload being received.

The encoder may be further configured to provide the main payload to a transmitter within the apparatus (i.e. a communication interface with the network or the like) for transmission to a receiving apparatus. The receiving apparatus may be an entity located in or across a network. Similarly, the encoder may be further configured to provide the redundant packet in a second packet to the transmitter. The transmitter is configured to transmit the second packet subsequent to the first packet. It is, in general, more useful to transmit the main and redundant payloads in different packets as the additional diversity provided by the second packet makes it more likely that at least one copy of the payload (either the main or redundant copy) will be received by the receiving entity. However, it is understood that some codecs define operations with respect to frames (and numbers of frames) instead of with respect to packets. In these cases, the main payload and the redundant payloads may be considered as being transmitted in different frames, rather than being considered as being transmitted in different packets.

It may be the case that, despite the additional diversity provided by the multiple packet/frame transmission of different versions of the same payload, that neither version is received correctly by the receiving entity. In this case, the transmitter may be configured to cause further transmissions of the same payload as an additional redundancy measure. In this case, the first encoded version of the payload is transmitted in a third packet, subsequent to both the first and second packets. The first payload may be encoded in a variety of ways. The first payload may be encoded at the first data rate (this is, in effect, a retransmission of the main payload, albeit in the third data packet). The first payload may be encoded at the second data rate (this is, in effect, a retransmission of the redundant packet, albeit in the third data packet). In both of these examples, no further encoding operations need to be performed by the encoder, as the transmitting entity may be configured to retain the main and/or redundant payloads for a minimum amount of time to enable the retransmission of any of these versions of the payload. As a third option, the first payload may be encoded at a third data rate for transmission in the third packet. The third data rate may be equal to or less than the first data rate, and different to the second data rate. Like the encoding of the redundant copy, the encoding of the first payload at the third data rate may utilise the existing main payload and re-encode it at a different (i.e. lower) data rate, or may simply re-use the unquantised state of the first payload (i.e. the state of the first payload before any quantisation has been performed to render it at a particular bitrate/data rate). This, again, saves the number of encoding steps to be performed by the encoder. The different encoded versions of the payload (using, for example, the first, second and third data rates) may be produced at substantially the same time in the encoder and stored in respective buffers. A transmitter configured to transmit those encoded packets may then select at least one main and redundant copy of that payload for transmission, in dependence on the available bitrate of the packet in which each copy of that payload is to be transmitted.

The encoded first payloads may be transmitted with other encoded payloads. To this effect, the encoder may also be configured to encode other (e.g. second and third) payloads in a similar way to the first payload mentioned above. These other payloads may be encoded at the same or at different rates to the first payload. Thus, in general, the encoder is configured to encode a second payload using a fourth data rate (aka the second main payload); to encode the second payload using a fifth data rate (aka the second redundant payload), wherein the fifth data rate is equal to or less than the fourth data rate; to encode a third payload using a sixth data rate (aka the third main payload); and to encode the third payload using a seventh data rate (aka the third redundant payload), wherein the seventh data rate is equal to or less than the sixth data rate. These encoded payloads may be arranged for transmission in a number of ways. It is understood that the second and third (and any subsequent) payloads may be transmitted and formed in the same way as the first payload. However, the above and following only refer to two data rates per subsequent payload for ease in conveying the following illustrative example.

The following illustrates how multiple redundant payloads relating to respective main payloads may be transmitted in the same packet. It is assumed that the first main payload is transmitted in the first packet. Subsequently, the second main payload is transmitted in the second packet with the first redundant payload. Subsequently, the third main payload is transmitted in the third packet with the second redundant payload, either with or without a version of the first payload (as described above in relation to the third packet). Consequently, multiple redundant payloads relating to respective main payloads may be transmitted in the same packet. The multiple redundancy payload technique is further improved by the use of being able to set the bitrate/data rate of the redundancy payloads as lower than the payload, as it is easier to fit the redundancy data into the same frame.

In order that the environment in which the present system may operate be understood, by way of example only, we describe a potential communication system and user equipment into which the subject-matter of the present application may be put into effect. It is understood that the exact layout of this network is not limiting.

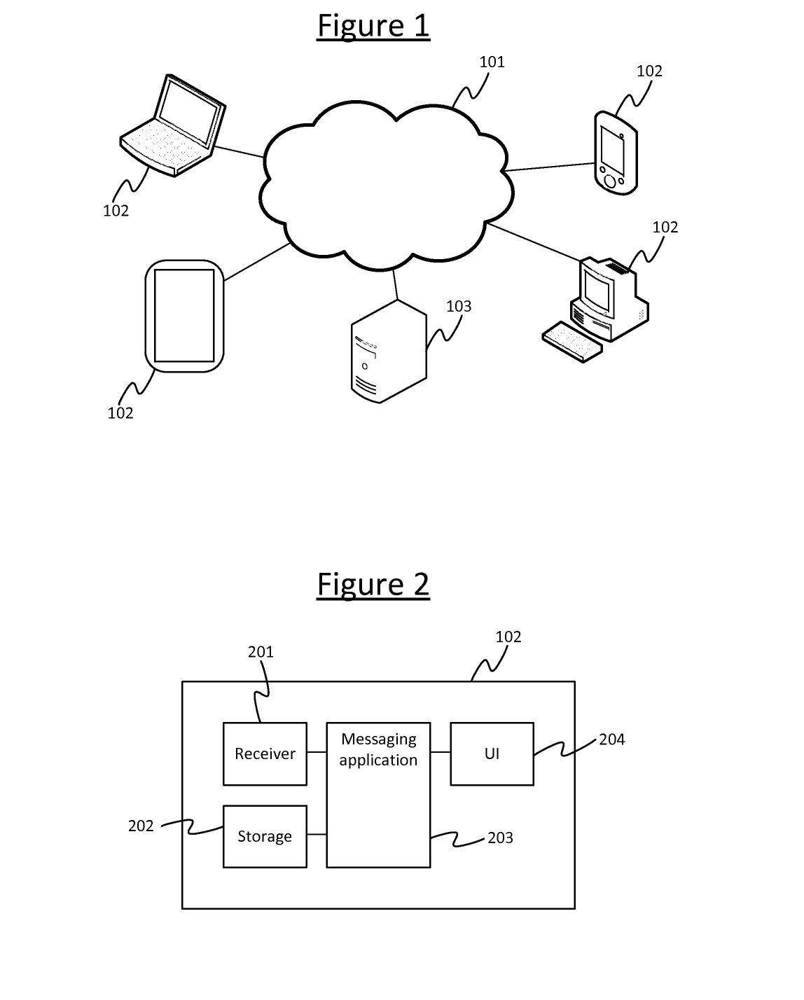

FIG. 1 shows an example of a communication system in which the teachings of the present disclosure may be implemented. The system comprises a communication medium 101, in embodiments a communication network such as a packet-based network, for example comprising the Internet and/or a mobile cellular network (e.g. 3GPP network). The system further comprises a plurality of user terminals 102, each operable to connect to the network 101 via a wired and/or wireless connection. For example, each of the user terminals may comprise a smartphone, tablet, laptop computer or desktop computer. In embodiments, the system also comprises a network apparatus 103 connected to the network 101. It is understood, however, that a network apparatus may not be used in certain circumstances, such as some peer-to-peer real-time communication protocols. The term network apparatus as used herein refers to a logical network apparatus, which may comprise one or more physical network apparatus units at one or more physical sites (i.e. the network apparatus 103 may or may not be distributed over multiple different geographic locations).

FIG. 2 shows an example of one of the user terminals 102 in accordance with embodiments disclosed herein. The user terminal 102 comprises a receiver 201 for receiving data from one or more others of the user terminals 102 over the communication medium 101, e.g. a network interface such as a wired or wireless modem for receiving data over the Internet or a 3GPP network. The user terminal 102 also comprises a non-volatile storage 202, i.e. non-volatile memory, comprising one or more internal or external non-volatile storage devices such as one or more hard-drives and/or one or more EEPROMs (sometimes also called flash memory). Further, the user terminal comprises a user interface 204 comprising at least one output to the user, e.g. a display such as a screen, and/or an audio output such as a speaker or headphone socket. The user interface 204 will typically also comprise at least one user input allowing a user to control the user terminal 102, for example a touch-screen, keyboard and/or mouse input.

Furthermore, the user terminal 102 comprises a messaging application 203, which is configured to receive messages from a complementary instance of the messaging application on another of the user terminals 102, or the network apparatus 103 (in which cases the messages may originate from a sending user terminal sending the messages via the network apparatus 103, and/or may originate from the network apparatus 103).

The messaging application is configured to receive the messages over the network 101 (or more generally the communication medium) via the receiver 201, and to store the received messages in the storage 202. For the purpose of the following discussion, the described user terminal 102 will be considered as the receiving (destination) user terminal, receiving the messages from one or more other, sending ones of the user terminals 102. Further, any of the following may be considered to be the entity immediately communicating with the receiver: as a router, a hub or some other type of access node located within the network 101. It will also be appreciated that the messaging application 203 receiving user terminal 102 may also be able to send messages in the other direction to the complementary instances of the application on the sending user terminals and/or network apparatus 103 (e.g. as part of the same conversation), also over the network 101 or other such communication medium.

The messaging application may transmit audio and/or visual data using any one of a variety of communication protocols/codecs. For example, audio data may be streamed over a network using a protocol known Real-time Transport Protocol, RTP (as detailed in RFC 1889), which is an end-to-end protocol for streaming media. Control data associated with that may be formatted using a protocol known as Real-time Transport Control Protocol, RTCP (as detailed in RFC 3550). Session between different apparatuses may be set up using a protocol such as the Session Initiation Protocol, SIP.

As mentioned above, the present application describes a system in which a payload and its redundant copy can be encoded at different bitrates to each other in response to an instruction to provide an encoded payload. In other words, there can be asymmetric allocation of available bandwidth between the main payload and its later transmitted redundant version. These operations are performed in response to a single request/instruction to return an encoded payload for transmitting in a frame as part of a packet. In essence, this means that a main (i.e. initial) payload can be transmitted in a first packet, having been encoded at a first bitrate, and a redundant (i.e. a copied version of the main) payload can be transmitted in a second packet (later than the first packet), having been encoded at a second bitrate, where the second bitrate is the same as or lower than the first bitrate.

To exemplify the above described techniques, the following describes specific examples and illustrative effects of the presently described system and contrasts it with the previously mentioned “100% frame replication method”.

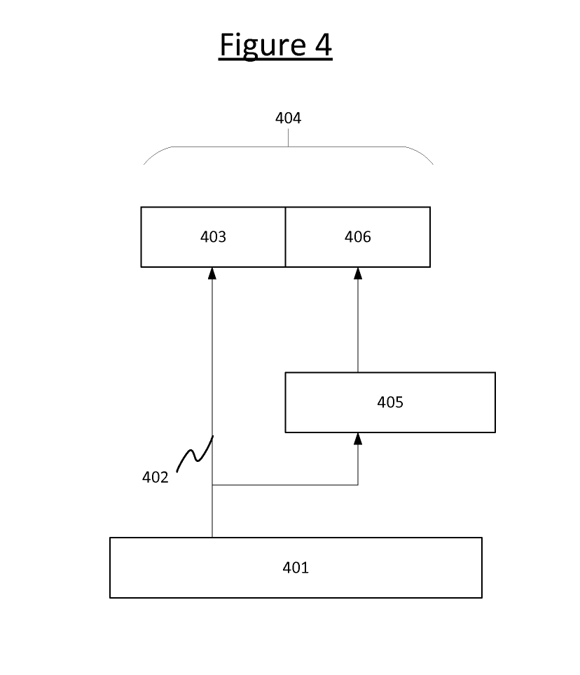

Currently, existing systems provide a symmetric distribution in bitrate between the main and redundant payloads in the “100% frame replication method”. This “100% frame replication method” is illustrated with respect to FIG. 4.

FIG. 4 shows an encoder 401 of a transmitter that is arranged to output a single encoded payload 402. This single encoded payload 402 is provided as a main payload 403 in a packet 404. The main payload 403 is the first transmission of the data forming the basis of that main payload. The single encoded payload 402 is also provided to a buffer 405 for later transmission as a redundant payload. The buffer 405 is also configured to provide a redundant payload 406 that corresponds to a payload contained within a previously transmitted packet (i.e. transmitted previously in time to packet 404). The redundant payload 406 is transmitted in the packet 404 with the main payload 403. Redundant payloads are transmitted within a number of packets and/or frames of their corresponding main payload, up to a set maximum (which may be set by a communication protocol). The redundant payloads are only transmitted when FEC is activated, which may occur at different times throughout transmission of an audio stream. In this example, both the main and redundant frames have the same payload type and same target bitrate. The actual bitrate for the two frames may vary for some codecs as the speech content between the main payload 403 and redundant payload 406 in the packet 404 may be different. It is further understood that the payloads 403 and 406 may be transmitted in respective frames, although this is not essential.

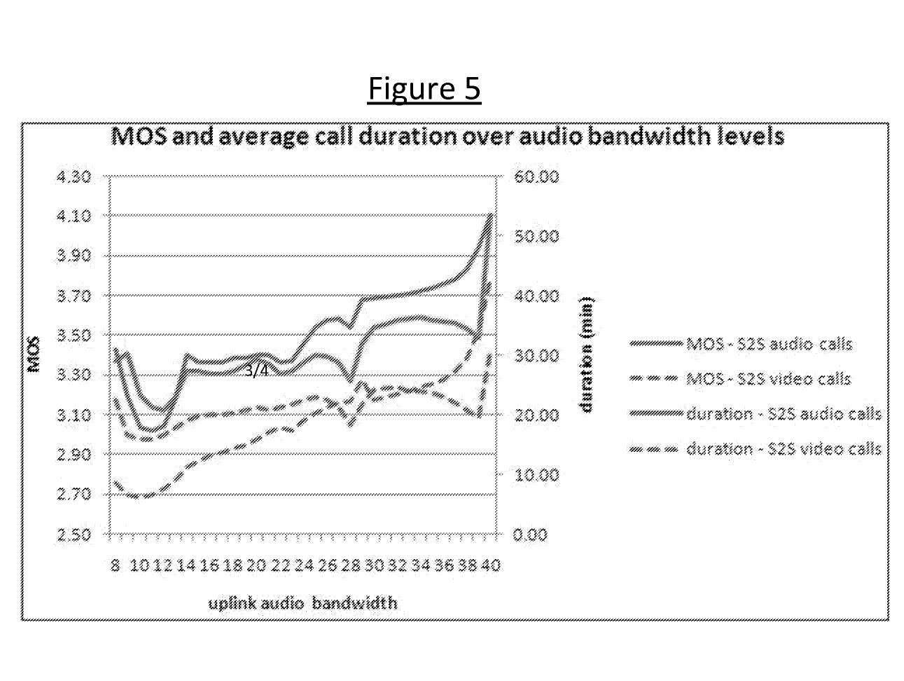

FIG. 5 illustrates the impact of the selection of bitrate used for audio encoding on the mean opinion score experienced by a user during an audio call. The mean opinion score is a metric that expresses the overall perception of a transmitted call quality, with 1 indicating a bad call connection and 5 indicating an excellent call quality. As is shown in FIG. 5, the MOS of both video and audio transmissions generally improves with the increase in available uplink audio bandwidth. Further, the duration traces in FIG. 5 display a sharp trough around the 38 kbps mark.

With reference to the previous system of symmetric bitrate encoding of the main and redundant payload, if the bandwidth available for audio data payloads is only 50 kbps, the previous systems are configured to use 25 kbps for the encoding of the main payload and 25 kbps for encoding the redundant payload whenever FEC is enabled.

In contrast, using the presently described system, there is an asymmetric distribution between the bit rate used to encode the main payload and the bit rate used to encode the redundant payload. Under this system, the encoder could choose to use, for example, 36 kbps (instead of 25 kbps) for encoding the main payload and only 14 kbps for encoding the redundant payload.

From the MOS traces shown in FIG. 5, this additional bitrate for encoding the main payload provides approximately a 0.2 user MOS benefit. In other words, compared to the 100% packet replication method, a user appears to have a better call quality when using the presently described asymmetric system. As, in fact, the design of the present system supports an arbitrary distribution of bits between the main and redundant encodes, which is limited only by the total bit budget available, the presently described system provides an important mechanism for improving the perception of the quality of a transmitted call.

The encoder may be configured to determine an optimal bitrate distribution between the main and redundant payloads given a bit budget (e.g. through a bandwidth allocation) and a known packet loss rate using tables/data such as those illustrated in FIG. 5. This data can be collated and formed offline through machine learning techniques applied to a set of network traces, using (for example) Perceptual Objective Listening Quality Assessment (POLQA) or Universal Human Relevance System (UHRS) testing as quality measures. POLQA is a standardized protocol for testing voice quality for fixed, mobile and IP based networks. UHRS is a proprietary crowdsourcing platform that can be used for testing voice quality of calls made over a network. The offline-optimized values can be validated and tuned through Embedded Control System controlled AB tests (an AB test is a method of testing in which one variable is changed, with the system A providing the control and the system B providing the contrasting treated system, in which a single variable has been altered relative to system A).

As mentioned above in the more general description, another benefit of reduced redundant payload size is that it enables multiple redundancy. Multiple redundancy is when more than one redundant payload can be sent with each main frame in a packet. Simulations performed using representative network traces indicate that multiple redundancy feature can reduce packet loss in poor network conditions (a poor network condition occurs when there is more than 10% average loss) on average by approximately 2.5% more than through the use of single redundancy measures alone (i.e. when a main payload is transmitted with a single redundancy payload).

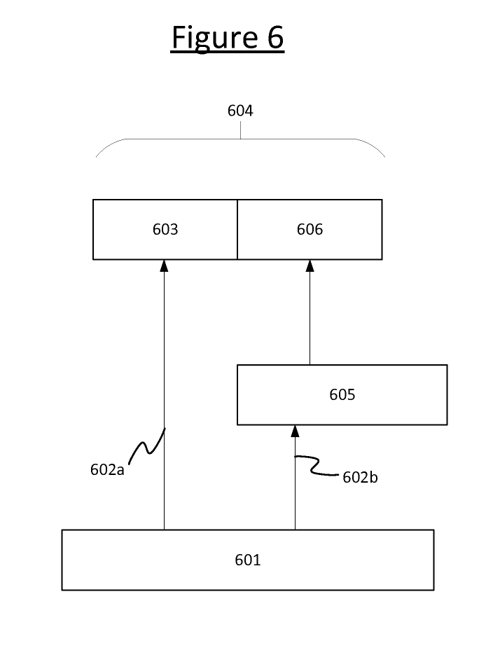

A specific example of how a transmitting apparatus may operate according to the presently described system is now provided with reference to FIG. 6.

FIG. 6 illustrates an encoder 601 configured to output two encoded versions 602a, 602b of a payload. This output of two encoded versions is performed in response to a single call (or request) for an encoded payload. The first version 602a represents the payload encoded using a first data rate and corresponds to the main payload mentioned above. The first portion is formatted into a packet 604 for transmission as a main payload 603. The second version 602b represents the payload encoded using a second data rate, the second data rate being at the same or lower rate to the first data rate. The second version 602b corresponds to the redundant payload mentioned above. The second version 602b is output to a buffer 605, which is configured to retain the redundant payloads for no more than a maximum separation distance from its corresponding main payload. A third version (not shown) may also be output from the encoder to another buffer (not shown). The third version may also correspond to one of the redundant payloads mentioned above. The packet 604 comprises both the main payload 603 corresponding to the first version 602a of the payload and a redundant payload 606 that is a version of a previously transmitted payload.

In operation, the media stack of the codec is configured to call the audio layer to obtain an encoded frame. If external FEC is enabled, the audio layer (represented as encoder 601 in FIG. 6) will return multiple frames, 602a, 602b: one encoded at the main target bitrate and at least two others encoded using a lower target bitrate. As discussed above, this does not necessarily mean three encode operations for each frame and a corresponding increase in complexity. Several internal encoder steps can be shared and only the final quantization steps need to repeated, once at each bitrate.

When requesting an encoded frame from the audio layer, the media stack may also indicate the total available bit budget. This information, together with an estimate of the prevailing packet loss rates, will allow the audio layer to decide on the distribution of available data rate between the bitrates used for the main and redundant payloads.

Both main and redundant frames share the same payload type (i.e. they use the same codec), but are encoded using different target bitrates.

For the presently described system, no change is required on the decoder side, since variable bitrate codecs (such as, for example, SILK, Opus and the EVS codecs) can inherently handle different varying/variable bitrates. This means that no protocol changes are needed on the decoder side since the payload type remains the same.

However, the encoder side, which is on the side of the transmitting entity, operates differently to previously known systems in that a lower target bitrate is explicitly selected when operating under a low bit rate redundancy scheme and in the corresponding quality control (QC) changes.

First, the differences on the encoder side resulting from adopting an asymmetric selection of bitrates for encoding the main and redundant payloads will be discussed, before discussing any changes to the corresponding QC tables, which are used to select a codec for transmitting the data.

Currently, a call to the encoder returns a single encoded frame. In the proposed design, two encoded frames need to be returned, each at different target bitrates. Calling the encoder twice will double computational complexity. Instead, a number of parameter extraction steps can be shared and only the quantization steps need to be repeated.

First a new Buffer ID is added to receive the redundant payloads encoded at the second data rate. This may be called “BUFFER_AudioEncodedRedundancy in the software code defining the buffers. Other buffer IDs may be added into the software code for redundant payloads encoded at other data rates. These buffer IDs may correspond to virtual buffers, such that all encoded payloads are placed in the same physical buffer/memory with different labelling/mapping being used to distinguish between the buffers corresponding to respective bitrates.

Secondly, when external FEC is set, every call to encode should populate both the buffer for the encoded main payload (labelled as “BUFFER_AudioEncoded”) and the buffers for the encoded redundant payloads (i.e. BUFFER_AudioEncodedRedundancy). For fixed bitrate codecs of the previously described systems, the buffers for the encoded redundant payloads receive the same payloads as the buffer for the encoded main payload. For variable bitrate codecs, the redundant bitrate can be less than or equal to the main bitrate

At the media stack level, whenever FEC is active, the transmitting device will read BUFFER_AudioEncodedRedundancy. The transmitting device will insert the redundant payload from this buffer with the correct offset into the RTP packet (depending on the active FEC distance).

For the bitrate split between main and redundant payload, the media stack layer will inform the audio layer about both the main payload bitrate as well as the total available audio bitrate (including FEC). When FEC is not enabled, these will be identical. When FEC is active, the total bitrate should be greater than the main payload bitrate. If there is a difference in these two values, this may be used to implicitly communicate to the audio layer that FEC is active.

Within the audio layer, allocation is optimally split between main and redundant payloads. This split will be opaque to the stack media layer. The stack layer also needs to communicate the send loss rate received through RTCP to the audio layer, using AESETTING_SendLossRate. This parameter is needed to determine the split between main and redundant bitrates.

Now, the effect on the QC bitrate table at the transmitter side is considered.

Currently, the encoder is configured to select a codec for encoding a payload for transmission in order to improve the transmission across a network medium. The codec selection is governed by the QC bitrate table, specifically by the final bitrate column in the table that provides the total bitrate requirement including header and redundancy overhead. A snapshot from this table is provided below:
{CODEC_ID_SILKWide, fmtSILKWide, 20, 36000, 58800, 94800, TRUE},
{CODEC_ID_SILKWide, fmtSILKWide, 20, 25000, 47800, 72800, TRUE},

The choice of bitrate for the main encode (36/25 kbps) is governed by the total bitrate available for audio (94.8/72.8 kbps). For example, 94.8 kbps is obtained as 36 kbps (main)+36 kbps (redundant)+22.8 kbps (RTP/IP/RTCP overhead). In the proposed design, if only 16 kbps is allocated for LBRR (low bit-rate redundancy), this will directly result in a bit rate savings of 20 kbps. By using offline tools such as POLQA/UHRS (described above), near-optimal values may be arrived at for the distribution of bits across the main and redundant representations for a given packet loss rate and available bandwidth. Furthermore, this parameter can be made ECS-controllable.

Below, some example scenarios involving the application of the teachings of the present application are outlined.

Example 1: Assume FEC is on. The QC table indicates that a particular codec should run at 25 kbps. The QC table accounts for 50 kbps (25 kbps for main and 25 kbps for redundant). The media stack layer provides both values (25k, 50k) as a call to the audio layer. For the audio layer, the only relevant information is that audio should not exceed 50 kbps. Based on the loss conditions, the audio layer may choose to split the bitrate as 36 kbps for main and 14 kbps for redundant encodes.

Example 2: Assume FEC is on. The QC table indicates that a particular variable codec should be used and run at 36 kbps. The QC table accounts for 72 kbps (36 kbps for main and 36 kbps for redundant). Since enough bandwidth is available in this case, the audio layer may choose to run at 100% redundancy.

Example 3: Assume FEC is on and the QC table indicates that a fixed bit rate codec should be used use. In this case, there is no change from current behaviour of the 100% packet replication method. The media stack layers provides (16 kbps, 32 kbps) as a call to the audio layer and the audio layer uses 16 k for the main and 16 k for the redundant payload.

Example 4: Assume FEC is off. The QC table indicates that a particular codec (either variable or fixed) should run at 25 kbps. The stack layer provides (25 kbps, 25 kbps). The audio layer uses 25 kbps for the main payload, and nothing for the redundant payload.

As mentioned above, the split between main and redundant bitrates needs to be learned from representative data. Based on available bandwidth, loss rate and speech characteristics, the optimal split between main and redundant payloads may be determined such that MOS is maximized (the optimal split may be determined using offline gathered data, such as from POLQA and/or UHRS).

In the above, reference is made to encoding a payload. It is understood that this payload is defined with respect to a unit of the communication protocol according to which the data is being transmitted. In general, the payload may be considered the minimum unit of information that may be transmitted in a frame. However, depending on the protocol, it may be that multiple payloads may be transmitted in a single frame. The frame may be part of a packet, which is a formatted unit of information that comprises transport-related information in an associated header that is suitable for routing the packet to and/or across a network. In this case, each payload may be separately indicated by a header in the frame and/or packet.

Further in the above, reference is made to data being encoded. In an embodiment, this is audio data. The audio data may comprise speech information. The encoder may be configured to both compress and encode the audio data, depending on the codec used. However, it is understood that the techniques described above may also be applied to the transmission of other data types (such as visual data) to and/or across a network.

Moreover, the above-described techniques have especial use in packet communication networks that use the Voice over Internet Protocol (VoIP), which is a set of protocols and methodologies for transmitting audio data over a communication medium.

Although reference is made in the above to multiple packets, it is understood that the designation of first, second, third etc. does not imply that these packets are transmitted immediately after each other and/or with no other transmission of data packets between them.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof In the case of a software implementation, the module, functionality, or logic represents program code that performs specified tasks when executed on a processor (e.g. CPU or CPUs). Where a particular device is arranged to execute a series of actions as a result of program code being executed on a processor, these actions may be the result of the executing code activating at least one circuit or chip to undertake at least one of the actions via hardware. At least one of the actions may be executed in software only. The program code can be stored in one or more computer readable memory devices. The features of the techniques described below are platform-independent, meaning that the techniques may be implemented on a variety of commercial computing platforms having a variety of processors.

For example, the user terminals configured to operate as described above may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

According to a first aspect, there is provided method comprising: in response to receiving a request for providing an encoded payload; encoding a first payload using at least three different data rates; outputting the encoded first payloads to respective buffers; and transmitting at least two of the encoded first payloads in respective frames, wherein the later transmitted encoded first payload is encoded at a data rate that is equal to or less than the data rate used to encode the first transmission of the first payload.

Said encoding the first payload using at least three data rates may comprise: encoding the first payload using a first data rate to create a first encoded first payload; encoding the first encoded first payload using a second data rate to create a second encoded first payload; and encoding one of the first and second encoded first payloads using a third data rate to create a third encoded first payload.

The request may comprise the total available audio bitrate and an expected packet loss rate. The method may further comprise: determining the at least three data rates in dependence on the total available audio bitrate and the expected packet loss rate. The method may further comprise: obtaining speech characteristics of audio in the first payload, and wherein the determining is further performed in dependence on said speech characteristics.

The method may further comprise: transmitting the first payload encoded using a first data rate in a first packet; transmitting the first payload encoded using a second data rate in a second packet, subsequent to the first packet; and transmitting the first payload encoded using the second data rate in a third packet, subsequent to the second packet.

The method may further comprise: transmitting the first payload encoded using a first data rate in a first packet; transmitting the first payload encoded using a second data rate in a second packet, subsequent to the first packet; and transmitting the first payload encoded at a third data rate in a third packet, subsequent to the second packet.

The method may further comprise: transmitting two versions of the same payload in the same packet. The two versions of the same payload may be encoded using the same data rate. The method may further comprise: encoding a second payload using a plurality of different data rates; and transmitting at least one of the encoded second payloads in the third packet.

According to a second aspect, there is provided an apparatus comprising: means for receiving a request for providing an encoded payload; means for encoding a first payload using different data rates; means for outputting the encoded first payloads to respective buffers; and means for transmitting at least two of the encoded first payloads in respective packets, wherein the later transmitted encoded first payload is encoded at a data rate that is equal to or less than the data rate used to encode the first transmission of the first payload.

The apparatus may further comprise means for encoding a first payload using different data rates by: comprising means for encoding the first payload using a first data rate to create a first encoded first payload; comprising means for encoding the first encoded first payload using a second data rate to create a second encoded first payload; and comprising means for encoding one of the first and second encoded first payloads using a third data rate to create a third encoded first payload.

The request may comprise the total available audio bitrate and an expected packet loss rate. The apparatus may further comprise: means for determining the different data rates in dependence on the total available audio bitrate and the expected packet loss rate. The apparatus may further comprise: means for obtaining speech characteristics of audio in the first payload, and wherein the determining is further performed in dependence on said speech characteristics.

The apparatus may further comprise: means for transmitting the first payload encoded using a first data rate in a first packet; means for transmitting the first payload encoded using a second data rate in a second packet, subsequent to the first packet; and means for transmitting the first payload encoded using the second data rate in a third packet, subsequent to the second packet.

The apparatus may further comprise: means for transmitting the first payload encoded using a first data rate in a first packet; means for transmitting the first payload encoded using a second data rate in a second packet, subsequent to the first packet; and means for transmitting the first payload encoded using a third data rate in a third packet, subsequent to the second packet.

The apparatus may further comprise: means for transmitting two versions of the same payload in the same packet.

The apparatus may further comprise: means for encoding a second payload using a plurality of data rates; and means for transmitting at least one of the encoded second payloads in the third packet.

According to a third aspect, there is provided a computer program comprising code means adapted to cause performing of the steps of any of the method claims when the program is run on data processing apparatus.

1. A method comprising:
in response to receiving a request for providing an encoded payload:
obtaining a speech characteristic of audio in a payload and determining a first data rate, a second data rate, and a third data rate for encoding the payload in dependence on the speech characteristic;
encoding the payload to generate a first encoded payload encoded at the first data rate, a second encoded payload encoded at the second data rate, and a third encoded payload encoded at the third data rate;
outputting the first, second, and third encoded payloads to respective buffers; and
transmitting at least two of the first, second, or third encoded payloads in respective frames, wherein a later transmitted encoded first, second, or third encoded payload is encoded at a data rate that is equal to or less than a data rate used to encode the earlier transmission of the first, second, or third encoded payload.

2. (canceled)

3. A method as claimed in claim 1, wherein the request comprises the total available audio bitrate and an expected packet loss rate.

4. A method as claimed in claim 3, further comprising determining the first data rate, the second data rate, and the third data rate in dependence on the total available audio bitrate and the expected packet loss rate.

5. (canceled)

6. A method as claimed in claim 1, further comprising:
transmitting the first encoded payload encoded using the first data rate in a first packet;
transmitting the second encoded payload encoded using the second data rate in a second packet, subsequent to the first packet; and
transmitting the second encoded payload encoded using the second data rate in a third packet, subsequent to the second packet.

7. A method as claimed claim 1, further comprising:
transmitting the first encoded payload encoded using the first data rate in a first packet;
transmitting the second encoded payload encoded using the second data rate in a second packet, subsequent to the first packet; and
transmitting the third encoded payload encoded at the third data rate in a third packet, subsequent to the second packet.

8. A method as claimed in claim 1, further comprising:
transmitting two versions of one or more of the first encoded payload, the second encoded payload, or the third encoded payload in a same packet.

9. A method as claimed in claim 8, wherein the two versions of the same encoded payload are encoded using the same data rate.

10. (canceled)

11. An apparatus comprising:
at least one processor; and
a memory comprising code that, when executed on the at least one processor, causes the apparatus to:
in response to receiving a request for providing an encoded payload:
obtain a speech characteristic of audio in a payload and determine data rates for encoding the payload in dependence on said speech characteristic;
encode the payload to generate a plurality of encoded payloads encoded at different data rates;
output the plurality of encoded payloads encoded at different rates to respective buffers; and
transmit at least two of the plurality of encoded payloads encoded at different data rates in respective frames, wherein a later transmitted encoded payload of the plurality of encoded payloads encoded at different rates is encoded at a data rate that is equal to or less than the data rate used to encode an earlier transmission of a different encoded payload of the plurality of payloads encoded at different rates.

12. An apparatus as claimed in claim 11, wherein the memory comprises further code that, when executed on the at least one processor, causes the apparatus to encode the payload to generate the plurality of encoded payloads encoded at different data rates by:
encoding the payload using a first data rate to create a first encoded payload;
encoding the payload using a second data rate to create a second encoded payload; and
encoding the payload using a third data rate to create a third encoded payload.

13. An apparatus as claimed in claim 11, wherein the request comprises the total available audio bitrate and an expected packet loss rate.

14. An apparatus as claimed in claim 13, wherein the memory comprises further code that, when executed on the at least one processor, causes the apparatus to:
determine the data rates of the plurality of encoded payloads encoded at the different data rates further in dependence on the total available audio bitrate and the expected packet loss rate.

15. (canceled)

16. An apparatus as claimed in claim 11, wherein the memory comprises further code that, when executed on the at least one processor, causes the apparatus to:
transmit the payload encoded using a first data rate in a first packet;
transmit the payload encoded using a second data rate in a second packet, subsequent to the first packet; and
transmit the payload encoded using the second data rate in a third packet, subsequent to the second packet.

17. An apparatus as claimed in claim 11, wherein the memory comprises further code that, when executed on the at least one processor, causes the apparatus to:
transmit the payload encoded using a first data rate in a first packet;
transmit the payload encoded using a second data rate in a second packet, subsequent to the first packet; and
transmit the payload encoded using a third data rate in a third packet, subsequent to the second packet.

18. An apparatus as claimed in claim 11, wherein the memory comprises further code that, when executed on the at least one processor, causes the apparatus to:
transmit two versions of the same encoded payload in a same packet.

19. (canceled)

20. A system comprising:
one or more processors as part of a data processing apparatus; and one or more computer-readable storage media storing computer-executable instructions that are executable by the one or more processors to perform operations including:
in response to receiving a request for providing an encoded payload:
obtaining a speech characteristic of audio in a payload and determining a first data rate, a second data rate, and a third data rate for encoding the payload in dependence on said speech characteristic;
encoding the payload to generate a first encoded payload encoded at the first data rate, a second encoded payload encoded at the second data rate, and a third encoded payload encoded at the third data rate;
outputting the first, second, and third encoded payloads to respective buffers; and
transmitting at least two of the first, second, or third encoded payloads in respective frames, wherein a later transmitted encoded first, second, or third encoded payload is encoded at a data rate that is equal to or less than a data rate used to encode the earlier transmission of the first, second, or third encoded payload.

21. A system as claimed in claim 20, wherein the request comprises the total available audio bitrate and an expected packet loss rate.

22. A system as claimed in claim 21, wherein the operations further include determining one or more of the first data rate, the second data rate, or the third data rate further in dependence on the total available audio bitrate and the expected packet loss rate.

23. A system as claimed in claim 20, wherein the operations further include:
transmitting the first encoded payload in a first packet;
transmitting the second encoded payload in a second packet subsequent to the first packet; and
transmitting the second encoded payload in a third packet subsequent to the second packet.

24. A system as claimed in claim 20, wherein the operations further include:
transmitting the first encoded payload in a first packet;
transmitting the second encoded payload in a second packet subsequent to the first packet; and
transmitting the third encoded payload in a third packet subsequent to the second packet.

25. A system as claimed in claim 20, further comprising:
transmitting two versions of one or more of the first encoded payload, the same second encoded payload, or the third encoded payload in a same packet.
